(19) United States
(12) Patent Application Publication
(10) Pub. No.: US 2025/0045675 A1
(43) Pub. Date: Feb. 6, 2025

(54) COMPUTERIZED SYSTEMS AND METHODS FOR APPLICATION-BASED DEVICE CONTROL BASED ON PREDICTED APPLICATION USAGE

(71) Applicant: PLUME DESIGN, INC., Palo Alto, CA (US)

(72) Inventor: Robert MILLER, Menlo Park, CA (US)

(21) Appl. No.: 18/363,203

(22) Filed: Aug. 1, 2023

(51) Int. Cl. G06Q 10/0639

(52) U.S. Cl. CPC G06Q 10/0639

(57) ABSTRACT

Disclosed are systems and methods that provide a computerized control and management framework that is configured to operate to control the manner in which applications and/or devices upon which such applications are executing can function, if at all. The disclosed framework can provide prediction features that leverage learned behaviors of users when interacting with an application and/or computing device (e.g., smart phone, for example). Accordingly, the disclosed framework can provide non-native capabilities to such Apps and/or devices to control, manage and/or modify how the Apps and/or associated devices can be accessed, utilized and/or interacted with by a user and/or other Apps, devices, platforms and systems.

### FIELD OF THE DISCLOSURE

The present disclosure is generally related to an application management system, and more particularly, to a decision intelligence (DI)-based computerized framework for automatically and dynamically controlling how applications and/or devices operate based on predictive analysis of such application's usage.

### BACKGROUND

Productivity is impacted by device usage. Typically, a user may take advantage of a smart device in order to take a break from a particular task. However, it is difficult for a user to gauge the amount of time that will be spent on applications (Apps)—for example, watching videos on YouTube® or reading social media posts on Twitter®.

### SUMMARY OF THE DISCLOSURE

Keeping a user's attention for as long as possible is the goal of these Apps. This lack of concern for productivity can have a negative impact on a user especially if there is an excessive amount of time (or mis-use of time) being spent on an App during working hours. While usage history may offer a perspective of time that has already been lost, it does not provide an assessment of potential lost time for a decision yet to be made. Hindsight can offer perspective on poor choices. However, a warning can help to avoid the poor choice altogether, tied with functionality for controlling how the device and/or App operates. The lack of a system configured to predict and/or utilize App and/or device usage is one of, among others, the technical shortcomings in existing systems.

To that end, according to some embodiments, the disclosed systems and methods provide a novel computerized usage prediction framework that addresses current shortcomings in the field by providing prediction features that leverage learned behaviors of users when interacting with an application and/or computing device (e.g., smart phone, for example). Accordingly, as discussed herein, the disclosed framework can provide non-native capabilities to such Apps and/or devices to control, manage and/or modify how the Apps and/or associated devices can be accessed, utilized and/or interacted with by a user and/or other Apps, devices, platforms and systems.

In some embodiments, as discussed herein, an App can refer to any type of computer program that is downloaded and/or network accessible executing on a device, such as, not limited to, electronic messaging services, social media sites, gaming programs, news services, video streaming services, and the like. For example, as discussed below, Apps can include, but are not limited to, downloadable and/or web-accessible Apps from a provider, for example, such as Google® or Apple®. The disclosed framework can determine and provide an estimate/projection of the amount of time a user will spend when an App is initiated/used. Such estimate/projection can be structured/compiled as a usage pattern (e.g., data structure), which can include information related to, but not limited to, a time period (e.g., day, hour) a user typically accesses the App, as well as the amount of time spent interacting with an App (as well as a type of activity, for example). As such, as provided below, such patterns can be leveraged to control functionality of an App and/or device, and/or provide notifications and/or mechanisms which can guide how an App and/or device can be accessed, written to and/or controlled.

In some embodiments, the framework can be configured to suggest alternate Apps that may increase productivity. For example, the framework may determine that rather than enabling a user access to a social media application during working hours, the disclosed framework can operate to present the user with an email application (or other work-related application) as an alternative to the social media site. In some embodiments, an alternate suggestion may be in response to selecting the “non-productive” App, or may be in response to a device command such as a phone unlocking before a user attempts to initiate the App.

According to some embodiments, a method is disclosed for a DI-based computerized framework for deterministically controlling and/or managing device and/or application usage by a user, another application and/or other device. In accordance with some embodiments, the present disclosure provides one or more computers comprising one or more non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for controlling and/or managing device and/or application usage by a user, another application and/or other device.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments are embodied in, by and/or on one or more non-transitory computer-readable media.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an example configuration workflow according to some embodiments of the present disclosure;

FIG. 4 illustrates an example execution workflow according to some embodiments of the present disclosure;

FIG. 5 depicts an example implementation of an architecture according to some embodiments of the present disclosure;

FIG. 6 depicts an example implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed framework provides an integrated, personalized control and management of a device and/or the applications executing thereon.

By way of a non-limiting example, according to some embodiments, a user may typically spend time on various Apps in various increments throughout a given day. For example, a user may spend 20 minutes reading a news App in the morning, engage in several 10-minute sessions scrolling through Facebook® around noon, listen to music for 30 minutes during an evening workout, and/or stream a movie before bed. In some embodiments, the disclosed systems and methods herein include the use of AI/ML mechanisms, algorithms and technologies, which can predict the amount of time a user spends with a particular App and/or type of App, and output a notification advising such predicted App/device usage and/or provide automated controls which can reduce and/or thwart/halt/stop such usage.

According to some embodiments, the discussion herein may focus on embodiments related to an App and/or smart device (e.g., smart phone); however, these examples should not be construed as limiting, as one of skill in the art would understand that the disclosed framework described herein can apply to various scenarios without departing from the scope of the instant disclosure. For example, in a professional environment, the system may be configured to predict the amount of time spent executing a standard operating procedure according to some embodiments. In some embodiments, the system may be configured to suggest alternatives to recreational Apps when a user is idle, such as email or unfinished training, as non-limiting examples.

Moreover, embodiments can exist where the disclosed framework can be applied to smart appliances, such as refrigerators, for example. For example, in some embodiments an appliance may offer alternatives such as suggesting a walk when undesirable patterns are detected. In the case of a smart refrigerator, for example, if access to the appliance is detected outside of normal (e.g., patterned) mealtimes, the appliance, through a network or wireless communication framework further described below, may warn the user that the appliance has been accessed multiple times within a time interval and that alternative options would be beneficial for health. In some embodiments, the system may be configured to initiate control of another device and/or appliance to encourage a particular type of behavior. By way of a non-limiting example, the system may initiate a message inviting the user to partake in a 5-minute session on an exercise bike alternative to a snack (e.g., whereby, in some embodiments, the exercise bike can communicatively be accessed and initiated as per user's account).

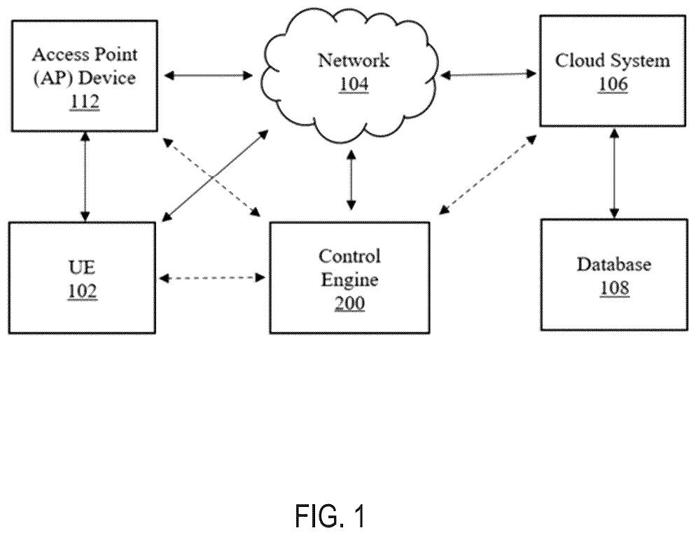

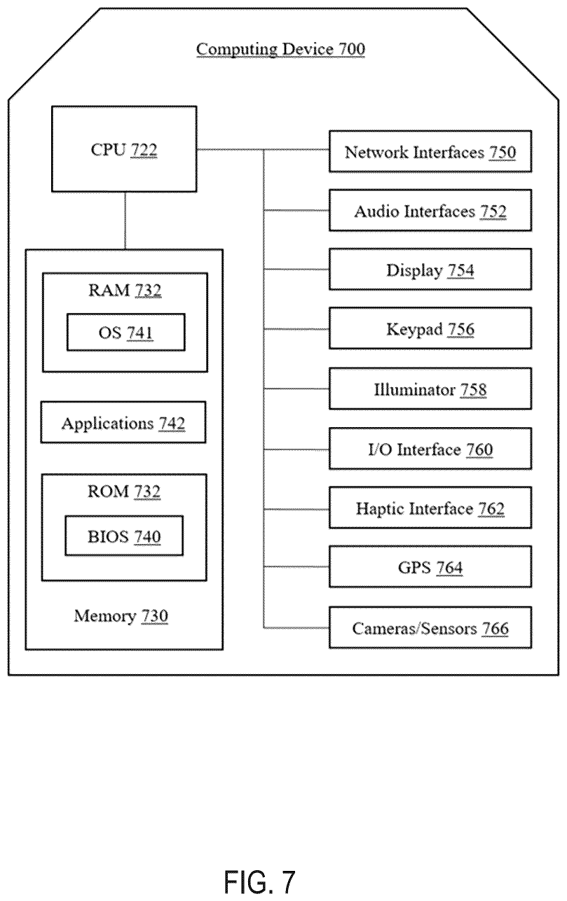

With reference to FIG. 1, system 100 is depicted which includes user equipment (UE) 102 (e.g., a client device, as mentioned above and discussed below in relation to FIG. 7), access point (AP) device 112, network 104, cloud system 106, database 108 and control engine 200. It should be understood that while system 100 is depicted as including such components, it should not be construed as limiting, as one of ordinary skill in the art would readily understand that varying numbers of UEs, AP devices, peripheral devices, cloud systems, databases and networks can be utilized; however, for purposes of explanation, system 100 is discussed in relation to the example depiction in FIG. 1.

According to some embodiments, UE 102 can be any type of device, such as, but not limited to, a mobile (smart) phone, tablet, laptop, Internet of Things (IoT) device, autonomous machine, appliance, and/or any other device equipped with a cellular and/or wireless or wired transceiver. For example, UE 102 can be a smart phone with various Apps installed.

In some embodiments, peripheral device (not shown) can be connected to UE 102, and can be any type of peripheral device, such as, but not limited to, a wearable device (e.g., smart ring or smart watch), printer, speaker, sensor, and the like. In some embodiments, peripheral device can be any type of device that is connectable to UE 102 via any type of known or to be known pairing mechanism, including, but not limited to, WiFi, Bluetooth™, Bluetooth Low Energy (BLE), NFC, and the like. For example, the peripheral device can be a speaker that connectively pairs with UE 102, which is a user's smart phone in some non-limiting examples.

According to some embodiments, AP device 112 is a device that creates a wireless local area network (WLAN) for the location. According to some embodiments, the AP device 112 can be, but is not limited to, a router, switch, hub and/or any other type of network hardware that can project a WiFi signal to a designated area. In some embodiments, UE 102 may include an AP device.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network-based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 200) the device control and management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, and the services and applications provided by cloud system 106 and/or control engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

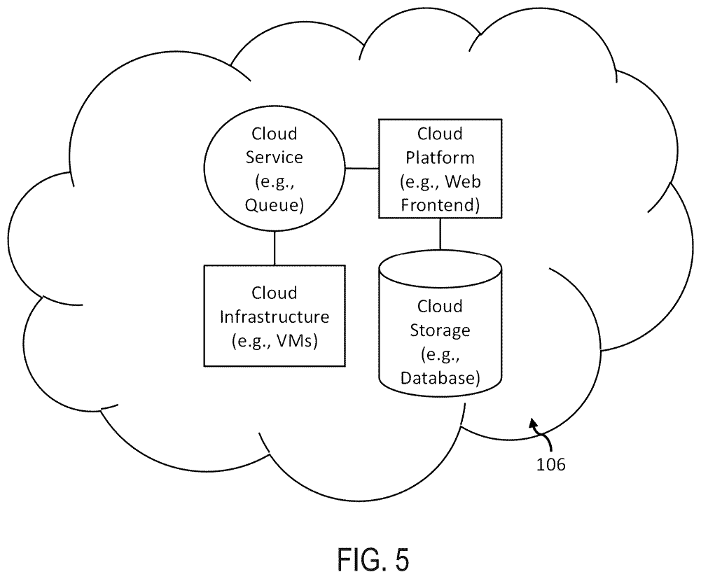

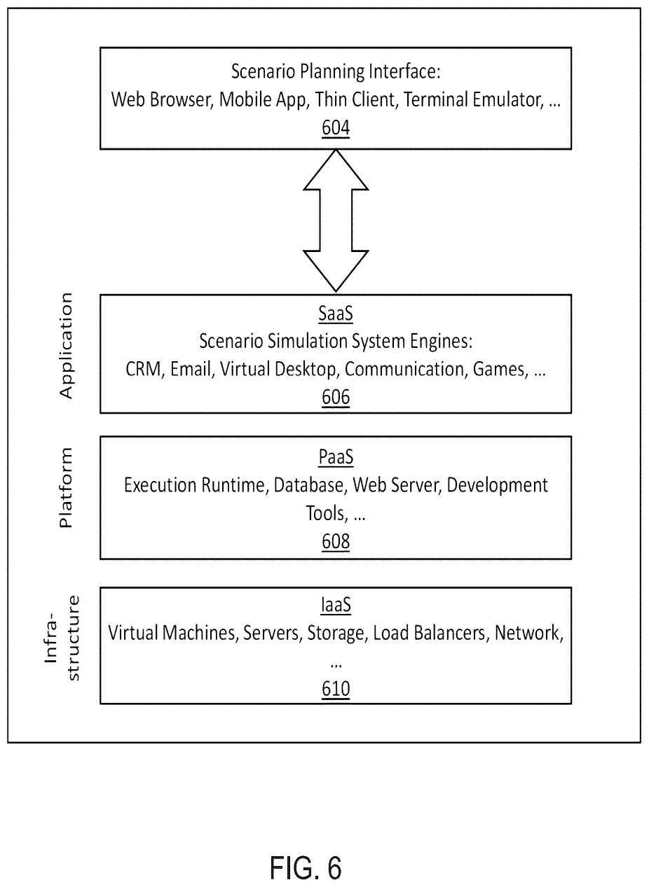

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 120 such as, but not limiting to: infrastructure as a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, control engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Control engine 200, as discussed above and further below in more detail, can include components for the disclosed functionality. According to some embodiments, control engine 200 may be a special purpose machine or processor, and can be hosted by a device on network 104, within cloud system 106, on AP device 112 and/or on UE 102. In some embodiments, control engine 200 may be hosted by a server and/or set of servers associated with cloud system 106.

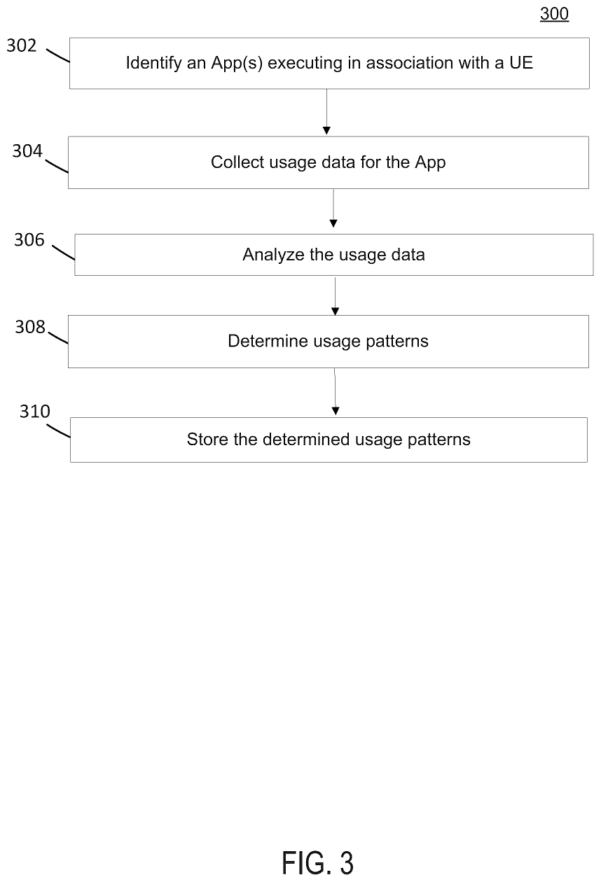

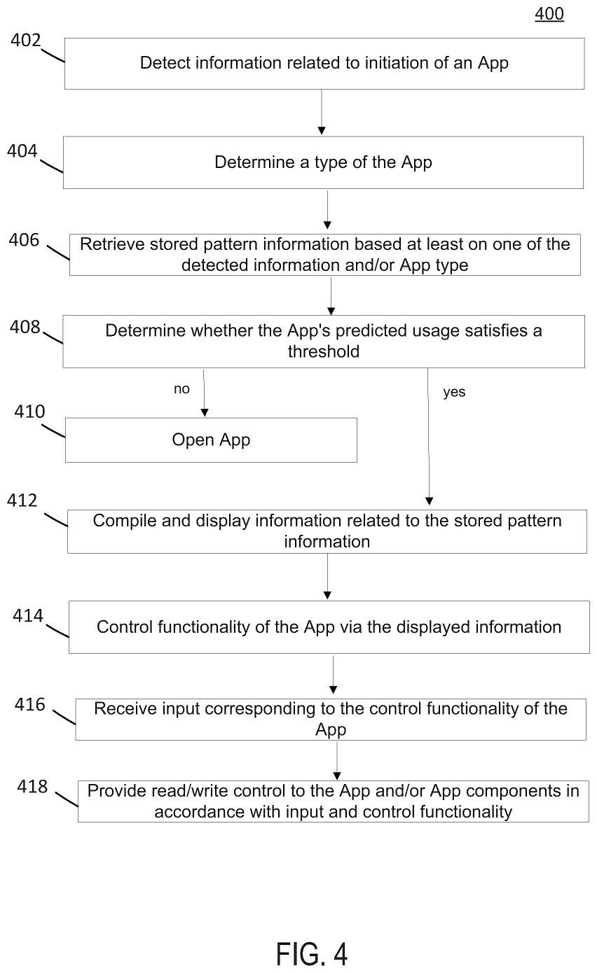

According to some embodiments, as discussed in more detail below, control engine 200 may be configured to implement and/or control a plurality of services and/or microservices, where each of the plurality of services/microservices are configured to execute a plurality of workflows associated with performing the disclosed application control and management framework. Non-limiting embodiments of such workflows are provided below in relation to at least FIGS. 3-4.

According to some embodiments, as discussed above, control engine 200 may function as an application provided by cloud system 106. In some embodiments, control engine 200 may function as an application installed on a server(s), network location and/or other type of network resource associated with system 106. In some embodiments, prediction control engine 200 may function as an application installed and/or executing on UE 102 (and/or AP device 112, in some embodiments). In some embodiments, such application may be a web-based application accessed by AP device 112 and/or UE over network 104 from cloud system 106. In some embodiments, control engine 200 may be configured and/or installed as an augmenting script, program or application (e.g., a plug-in or extension) to another application or program provided by cloud system 106 and/or executing on AP device 112 and/or UE 102.

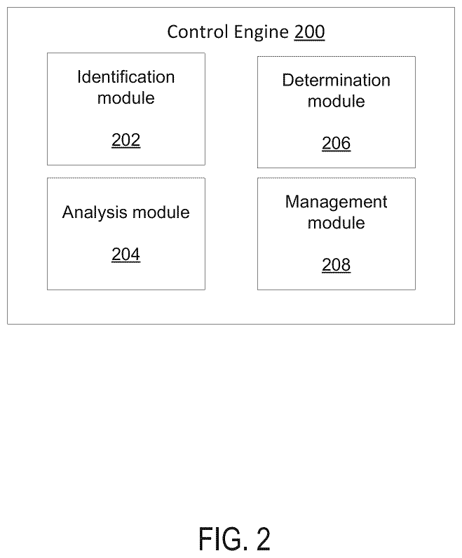

As illustrated in FIG. 2, according to some embodiments, control engine 200 includes identification module 202, analysis module 204, determination module 206 and management module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of control engine 200 and each of its modules, and their role within embodiments of the present disclosure will be discussed below.

Turning to FIG. 3, Process 300 provides non-limiting example embodiments for the disclosed control framework. According to some embodiments, Process 300 provides non-limiting embodiments for determining user information and corresponding patterns of behavior for which the disclosed framework (e.g., via control engine 200) can control, manage and manipulate the one or more Apps installed on UE 102. Steps described in the figures represent both an execution of a computer algorithm and a method of implementing the system.

According to some embodiments, Steps 302-304 of Process 300 can be performed by identification module 202 of control engine 200; Step 306 can be performed by analysis module 204; and Steps 308-310 can be performed by determination module 206.

It should be understood that while the discussion herein will be with reference to an App(s) executing on a device, it should not be construed as limiting, as any type of program, website, network resource, platform or device (e.g., any of the UEs discussed above) can form the basis of determining patterns of activity, as discussed herein, without departing from the scope of the instant disclosure.

According to some embodiments, Process 300 begins with Step 302 where engine 200 can identify one or more Apps on UE 102. As discussed supra, reference to an App can include any program that can be access, hosted, stored and/or executed by UE 102 (e.g., apps installed on UE 102 and/or accessed by UE 102 via network 104)—for example, social media applications, messaging applications (e.g., email, SMS, MMS), health applications, news applications, calendar applications, and the like.

In some embodiments, engine 200 is configured to categorize each type of App. In some embodiments, Step 302 can involve the identification of and/or determination of a category of the Apps. In some embodiments, the data and/or metadata of the application, as well as the registry information available on the device can be analyzed to determine a type of application. Indeed, in some embodiments, identifying information corresponding to the App can be identified, which can include, but is not limited to, App identifier (ID), version, model of device executing on, App provider, network location, and the like, or some combination thereof. In some embodiments, the type/category of application can be determined and/or provided, and can correspond to a manner in which the App is used. For example, social media Apps generally could be categorized as “recreational”; however, if the user is an employee of Meta®, for example, such application could be categorized as “work” related. In some embodiments, such category can be based on identifying information about the user, such demographic information and/or provided information input by a user responsive to a provided prompt within a graphical user interface (GUI).

In Step 304, engine 200 can collect usage data from one or more programs (Apps). In some embodiments, such collection can be based on a time period for collection, an event (e.g., initiation of the App), runtime of the application, and/or via continuous monitoring of the device executing the Apps. In some embodiments, the collected data (referred to as “usage data”, interchangeably), can include information related to, but not limited to, a time frame and/or duration of usage (or App execution), an initiation and/or end time of App execution, types of activities performed, ID of the user, account information, and the like, or some combination thereof. In some embodiments, such collected data can be stored in database 108 as labeled data corresponding to an App ID, user ID and/or category ID.

In Step 306, engine 200 can analyze the collected usage data. According to some embodiments, the analysis can involve any type of known or to be computational analysis that can enable engine 200 to derive, determine, extract, retrieve or otherwise identify usage pattern information for the user respective to the one or more Apps. In some embodiments, such computational analysis can involve parsing the usage data, and extracting information indicating times, duration, activity, and the like.

In some embodiments, such computational analysis can involve engine 200 executing any type of known or to be known computational analysis technique, algorithm, mechanism or technology. In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, control engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, control engine 200 can implement an XGBoost algorithm for regression and/or classification to analyze the sensor data, as discussed herein.

According to some embodiments, the AI/ML computational analysis algorithms implemented can be applied and/or executed in a time-based manner, in that collected sensor data for specific time periods can be allocated to such time periods so as to determine patterns of activity (or non-activity) according to a criteria. For example, control engine 200 can execute a Bayesian determination for a predetermined time span, at preset intervals (e.g., a 24 hour time span, every 8 hours, based on learned/understood activity (e.g., bedtime), and the like, for example), so as to segment the day according to applicable patterns, which can be leveraged to determine, derive, extract or otherwise activities/non-activities for the user respective to the App(s).

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
c. apply the trained model to process the newly-received input data,
f. optionally and in parallel, continue to train the trained model with a predetermined periodicity.

In some embodiments and, optionally, in combination of any embodiment described above or below, the trained AI model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained AI model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, based on the analysis from Step 306, engine 200 can determine a set of patterns for a user(s) for one or more Apps. According to some embodiments, the determined patterns are based on the computational AI/ML analysis performed via engine 200, as discussed above.

In some embodiments, the set of patterns can correspond to, but are not limited to, types of events, types of detected activity, a time of day, a date, type of user, duration, amount of activity, quantity of activities, and the like, or some combination thereof. Accordingly, the patterns can be specific to a user, specific to the one or more Apps (from Step 302) and/or the device(s) executing such Apps.

For example, a specified pattern of activity for a user may correspond to a specific day of the week, and a specific time. For example, a pattern may correspond to a “bedtime routine” of a user, whereby the user is determined to check their phone and access a social media site before they go to sleep (e.g., Instagram®) for two (2) hours. Thus, as discussed below at least in relation to FIG. 4, the disclosed control framework can automatically display a predicted usage based on previous patterns of usage for an App(s). And, in some embodiments, such display can be automated, such that, rather than simply enabling the user access to such App, access times can be reduced, access (e.g., read controls to specific features) can be declined and/or network usage can be throttled thereby limiting the time and/or activity of such App.

In Step 310, engine 200 can store the determined set of patterns in database 108, in a similar manner as discussed above. According to some embodiments, Step 310 can involve creating a data structure associated with each determined pattern, whereby each data structure can be stored in a proper storage location associated with a data label, as discussed above.

In some embodiments, a pattern can comprise a set of events, which can correspond to an activity or set of activities per App session. In some embodiments, the pattern's data structure can be configured with header (or metadata) that identifies a user and/or App, and/or a time period/interval (e.g., that can correspond to the collection and/or analysis, as discussed above); and the remaining portion of the structure providing the data of the activity and status of App usage during such sequence(s). In some embodiments, the data structure for a pattern can be relational, in that the events of a pattern can be sequentially ordered, and/or weighted so that the order corresponds to events with more or less activity.

In some embodiments, the structure of the data structure for a pattern can enable a more computationally efficient (e.g., faster) search of the pattern to determine if later detected events correspond to the events of the pattern, as discussed below. In some embodiments, the data structures of patterns can be, but are not limited to, files, arrays, lists, binary, heaps, hashes, tables, trees, and the like, and/or any other type of known or to be known tangible, storable digital asset, item and/or object.

According to some embodiments, the collected usage data can be identified and analyzed in a raw format, whereby upon a determination of the pattern, the data can be compiled into refined data (e.g., a format capable of being stored in and read from database 108). Thus, in some embodiments, Step 310 can involve the creation and/or modification (e.g., transformation) of the usage data into a storable format, which is then stored.

In some embodiments, as discussed below, each pattern (and corresponding data structure) can be modified and/or updated based on further detected behavior, as discussed below in relation to Process 400 of FIG. 4.

Turning to FIG. 4, Process 400 provides non-limiting example embodiments for the deployment and/or implementation of the disclosed usage prediction framework. According to some embodiments, Step 402 of Process 400 can be performed by identification module 202 of control engine 200; Steps 404-408 can be performed by determination module 206; and Steps 410-418 can be performed by management module 208.

According to some embodiments, Process 400 begins with Step 402 where engine 200 receives a detection signal that an App has been initiated (e.g., a request to open the App). In some embodiments, such signal can correspond to, but not be limited to, input from a user, input from another App or function on a device, a request, detection of instructions corresponding to the registry, memory or other location on/associated with the device for which causes an App to open, reload and/or be maximized for display within the display of the device.

According to some embodiments, Step 402 can involve the identification of information related to, but not limited to, App ID, device ID, user ID, a time, date, location, and the like, or some combination thereof. The identification of such information can be performed in a similar manner as discussed above respective to at least Step 302, inter alia.

In some embodiments, while the discussion herein focuses on App “initiation” (e.g., opening an application that was previously closed or not running), it should not be construed as limiting, as Step 402 (and the functionality of Process 400, as discussed herein) can be performed respective to an App that was open but running in the background, whereby Step 402 can involve the identification of the App as being presently displayed within the user interface (UI)/display of a device, whereby interaction by a user has commenced (e.g., logging in, interacting with App content, and the like).

In Step 404, engine 200 can determine a type of the initiated App. According to some embodiments, the type of App can be determined in a similar manner as discussed respective to at least Steps 302 and/or 304 (e.g., identify type/category of App), discussed supra.

In Step 406, engine 200 can retrieve pattern information corresponding to information related to the App initiated in Step 402. In some embodiments, such retrieval can additionally or alternatively be based on a type of App (from Step 404). In some embodiments, the pattern information, which can be retrieved from database 108, as discussed above, can correspond to, but not limited to, a type of the App, the App ID, device ID, user ID, a time, date, and the like.

In Step 408, engine 200 can analyze the retrieved pattern information (406) and the App information (from Steps 402 and/or 404) and determine whether the App corresponds to a “vigilance” category (e.g., a vigilance type of usage of the App). That is, in other words, according to some embodiments, engine 200 can execute Step 408 to determine whether the App corresponds to activity of the user that can present a drain on the user's time. According to some embodiments, the analysis and determination of Step 408 can be performed via engine 200 executing any of the known or to be known AI/ML techniques discussed above.

Accordingly, as used herein, an App's vigilance determination can correspond to an App that, via the user's pattern activity, involves the user's engagement with the App at least a threshold amount of time (e.g., more than 1 hour, for example), which as discussed herein, can be a non-vital usage of the user's time based on the App's category or type, and/or type of activity and/or content interacted with via the App.

According to some embodiments, when engine 200, via Step 408, determines that the App's predicted usage is below a threshold amount of time (which can be specific to the App, a type of App, the user, device and the like, or some combination thereof), processing of Process 400 can proceed from Step 408 to Step 410. In Step 410, engine 200 can enable the App to be opened. In some embodiments, such opening can be performed without additional data (e.g., provide read/write access without any safeguards or annotations to the opening of the App). In some embodiments, Step 410 may provide an indication as to App usage, which can aid the user in understanding typical/predicted interaction durations for such App and/or App type.

According to some embodiments, when engine 200, in Step 408, determines that the App's usage is at or above a threshold (e.g., an application that the user typically executes that is non-vital to their time), then engine 200 can proceed to Step 412. For example, a user typically opens their social media application before going to sleep, and such usage lasts at least 2 hours, well above the 30 minute threshold. It should be understood that such thresholds can be time, date and/or user specific, in that 2 hours of social media usage in the middle of the day on a weekend may not cause engine 200 to proceed to Step 412, but rather Step 410 since such threshold for a weekend midday pattern can be 3 hours, for example.

In Step 412, engine 200 can compile and cause display of an electronic message and/or notification that includes information corresponding to the retrieved pattern of activity. According to some embodiments, engine 200 can compile the pattern usage information (retrieved from Step 406, discussed supra) and generate an electronically displayable interface object (IO-a notification, pop-up or message) that includes content depicting metrics corresponding to the user's known usage of the application. Such information can include data related to, but not limited to, duration, frequency, types of activity, and the like. In some embodiments, such IOs and/or content can be interactive, such that upon selection of the IOs/content, related graphical indicators or metrics can be displayed depicting the patterns of activity for the user upon which Step 408's determination is based.

For example, if the user is generally known to open their Twitter® application before bedtime, then engine 200 compile a displayable notification that visibly displays the time the user typically is on Twitter, which can be displayed prior to the App opening and/or contemporaneously with its opening. Thus, Step 412 can be executed before the App is opened or upon the Apps opening. In some embodiments, the notification can be contemporaneously displayed with the App's opening, which can cause the user to accept/decline the notification prior to usage of the App, as discussed below.

Accordingly, in some embodiments, the message/notification provided via Step 412 is configured to provide functionality for controlling, managing and/or operating the App, as discussed below in Step 414.

In Step 414, engine 200 can therefore provide functionality and/or control of the App. In some embodiments, for example, engine 200 provide functionality that enables the App to be closed, prevented from opening, opened for a predetermined time period (e.g., a time 20% less than the predicted app usage), closed after n minutes of opening, and the like, or some combination thereof. Further, in some embodiments, engine 200 can enable the opening or viewing of an App page or user interface (UI); however, certain aspects, functions or features of the App may be disabled until a notification is responded to, as discussed infra. For example, engine 200 can facilitate and/or cause control that can include causing a timer to be presented to the user (e.g., whereby upon expiration of the timer, the App is caused to be closed automatically upon the detection that no user input was received).

Accordingly, in Step 414, engine 200 can cause a prompt, display or other type of displayable window (e.g., overlay, pop-up or adjacent window) that includes functionality for the user to accept or decline the suggested/recommended actions (e.g., do not open App, open for a suggested time, use a different App, and the like). In some embodiments, the prompt can include a generated message from an executed large language model (LLM) that suggests an activity for the user (e.g., try a different App, visit another network resource, perform a real-world activity (e.g., go to sleep), and the like).

According to some embodiments, by way of non-limiting example, in the case of a work setting, engine 200 can be configured to suggest opening an alternate application, such as work-related email, or unfinished training. In another non-limiting example, in a home setting, when a user turns on a television, engine 200 can recognize that typically a user should be at the gym, (e.g., based on a health App associated with the system framework) and may prompt the user with a message such as “We have not reached your daily workout goals, are you sure you wish to continue?” Other alternative commands include sending a signal to instruct an App or smart device to perform a specific action. For example, engine 200 may send a command to prevent an App from being opened, or prevent a smart lock on a door from being unlocked (e.g., via network 104), as non-limiting examples. In some embodiments, the system is configured to prompt a user via a GUI to set alternative commands and/or displays for Apps and/or scenarios.

In Step 416, engine 200 can store a response to the provided prompt from Step 414. For example, a choice, selection, input and/or automated control of the App and/or device can be identified and stored, and utilized to update the predicted pattern for that user, App, App type and/or device. For example, if a user chooses to close the App, the choice can be recorded. Likewise, if a user simply does not engage with the App any further, and/or dismisses the warning prompt and continues to the App, this can be stored in database 108. And, should the App be automatically declined via engine 200, information corresponding to such decline operation can be stored in a similar manner.

In Step 418, engine 200 can cause, enable or facilitate, or otherwise provide functionality for the App and/or device to the user via the operations performed in Step 414 and stored in Step 416. Accordingly, in some embodiments, Step 418 can involve engine 200 providing read/write control(s) to the App and/or App features/components in accordance with the received input responsive to the displayed and managed control functionality (of Steps 414 and 416, discussed supra).

FIG. 7 is a schematic diagram illustrating a client device showing an example embodiment of a client device that may be used within the present disclosure and/or the framework illustrated in FIG. 1. Client device 700 may include many more or less components than those shown in FIG. 7, such as a plurality of one or more computers. However, the components shown are sufficient to disclose an illustrative embodiment for implementing the present disclosure. Client device 700 may represent, for example, UE 102 discussed above at least in relation to FIG. 1.

As shown in the figure, in some embodiments, client device 700 includes one or more processors (CPU) 722 in communication with one or more non-transitory computer readable media 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device 700 may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules, usage data, or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus, device and/or computer-readable medium functionality:

Aspect 1. A method comprising:
identifying, by a device, a request corresponding to an application;
analyzing, by the device, data related to the application and the request, and determining, based on the analysis, application information;
retrieving, by the device, from a datastore, pattern information related to the application, the retrieval being based on the determined application information; and
controlling, by the device, the application based on the pattern information, the control comprising capabilities for modified display of application content and management of application features.

Aspect 2. The method of aspect 1, further comprising:
analyzing the pattern information;
compiling an application notification, the application notification comprising interactive content corresponding to a predicted pattern of activity as indicated by the pattern information;
and causing display of the application notification.

Aspect 3. The method of aspect 2, wherein the display of the application notification occurs at a time related to one of a time prior to opening of the application and upon opening the application.

Aspect 4. The method of aspect 2, wherein the application notification comprises information indicating and providing the control.

Aspect 5. The method of aspect 1, further comprising:
analyzing activity of a user related to the application for a time period;
determining a set of activity patterns; and
storing the set of activity patterns in the datastore, wherein the pattern information is retrieved from the set of activity patterns.

Aspect 6. The method of aspect 1, further comprising:
determining, upon analysis of the pattern information, to enable access to the application without the control, the enabled access determination based on a predicted application usage being below a threshold amount of time.

Aspect 7. The method of aspect 1, wherein the control of the application corresponds to at least one of modified access to application features, modified access time to the application and denial of access to the application.

Aspect 8. The method of aspect 1, wherein the determined application information comprises at least one of a type of application, identifier (ID) of the application, ID of a user and ID of the device.

Aspect 9. The method of aspect 1,
wherein the data related to the application comprises indictors of at least one of an application type, application identifier (ID) and application status, and
wherein the data related to the request comprises at least one of a time, date and ID of a user.

Aspect 10. The method of aspect 1, wherein the request corresponds to at least one of opening of the application and rendering a page of the application within a foreground of a display of the device.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by a device, a request corresponding to an application;
analyzing, by the device, data related to the application and the request, and determining, based on the analysis, application information;
retrieving, by the device, from a datastore, pattern information related to the application, the retrieval being based on the determined application information; and
controlling, by the device, the application based on the pattern information, the control comprising capabilities for modified display of application content and management of application features.

2. The method of claim 1, further comprising:
analyzing the pattern information;
compiling an application notification, the application notification comprising interactive content corresponding to a predicted pattern of activity as indicated by the pattern information; and
causing display of the application notification.

3. The method of claim 2, wherein the display of the application notification occurs at a time related to one of a time prior to opening of the application and upon opening the application.

4. The method of claim 2, wherein the application notification comprises information indicating and providing the control.

5. The method of claim 1, further comprising:
analyzing activity of a user related to the application for a time period;
determining a set of activity patterns; and
storing the set of activity patterns in the datastore, wherein the pattern information is retrieved from the set of activity patterns.

6. The method of claim 1, further comprising:
determining, upon analysis of the pattern information, to enable access to the application without the control, the enabled access determination based on a predicted application usage being below a threshold amount of time.

7. The method of claim 1, wherein the control of the application corresponds to at least one of modified access to application features, modified access time to the application and denial of access to the application.

8. The method of claim 1, wherein the determined application information comprises at least one of a type of application, identifier (ID) of the application, ID of a user and ID of the device.

9. The method of claim 1,
wherein the data related to the application comprises indictors of at least one of an application type, application identifier (ID) and application status, and
wherein the data related to the request comprises at least one of a time, date and ID of a user.

10. The method of claim 1, wherein the request corresponds to at least one of opening of the application and rendering a page of the application within a foreground of a display of the device.

11. A device comprising:
a processor configured to:
identify a request corresponding to an application;
analyze data related to the application and the request, and determine, based on the analysis, application information;
retrieve, from a datastore, pattern information related to the application, the retrieval being based on the determined application information; and
control the application based on the pattern information, the control comprising capabilities for modified display of application content and management of application features.

12. The device of claim 11, wherein the processor is further configured to:
analyze the pattern information;
compile an application notification, the application notification comprising interactive content corresponding to a predicted pattern of activity as indicated by the pattern information; and
cause display of the application notification,
wherein the display of the application notification occurs at a time related to one of a time prior to opening of the application and upon opening the application, and
wherein the application notification comprises information indicating and providing the control.

13. The device of claim 11, wherein the processor is further configured to:
analyze activity of a user related to the application for a time period;
determine a set of activity patterns; and
store the set of activity patterns in the datastore, wherein the pattern information is retrieved from the set of activity patterns.

14. The device of claim 11, wherein the processor is further configured to:
determine, upon analysis of the pattern information, to enable access to the application without the control, the enabled access determination based on a predicted application usage being below a threshold amount of time.

15. The device of claim 11, wherein the control of the application corresponds to at least one of modified access to application features, modified access time to the application and denial of access to the application.

16. A non-transitory computer-readable storage medium tangibly encoded with computer-executable instructions, that when executed by a device, perform a method comprising:
identifying, by the device, a request corresponding to an application;
analyzing, by the device, data related to the application and the request, and determining, based on the analysis, application information;
retrieving, by the device, from a datastore, pattern information related to the application, the retrieval being based on the determined application information; and
controlling, by the device, the application based on the pattern information, the control comprising capabilities for modified display of application content and management of application features.

17. The non-transitory computer-readable storage medium of claim 16, further comprising:
analyzing the pattern information;
compiling an application notification, the application notification comprising interactive content corresponding to a predicted pattern of activity as indicated by the pattern information; and
causing display of the application notification,
wherein the display of the application notification occurs at a time related to one of a time prior to opening of the application and upon opening the application, and
wherein the application notification comprises information indicating and providing the control.

18. The non-transitory computer-readable storage medium of claim 16, further comprising:
analyzing activity of a user related to the application for a time period;
determining a set of activity patterns; and
storing the set of activity patterns in the datastore, wherein the pattern information is retrieved from the set of activity patterns.

19. The non-transitory computer-readable storage medium of claim 16, further comprising:
determining, upon analysis of the pattern information, to enable access to the application without the control, the enabled access determination based on a predicted application usage being below a threshold amount of time.

20. The non-transitory computer-readable storage medium of claim 16, wherein the control of the application corresponds to at least one of modified access to application features, modified access time to the application and denial of access to the application.
